(19) United States
(12) Patent Application Publication
(10) Pub. No.: US 2012/0091410 A1
(43) Pub. Date: Apr. 19, 2012

(54) WINDING DRUM AND METHOD FOR OPERATING A WINDING DRUM

(75) Inventors: Ludger Bünker, Emsburen (DE); Mario Möbes, Lorrach (DE); Stefan Sommerschuh, Pobershau (DE)

(73) Assignee: Stemmann-Technik GmbH, Schüttorf (DE)

(21) Appl. No.: 13/089,727

(22) Filed: Apr. 19, 2011

(30) Foreign Application Priority Data
Apr. 19, 2010 (DE) 10 2010 015 624.8

(51) Int. Cl. B66C 13/12; B66D 1/08

(52) U.S. Cl. 254/361

(57) ABSTRACT

In a method of operating a winding drum, in particular of cranes, for a line to be reeled in or paid out, a hydraulic motor is activated by a control block which has a hydraulic valve assembly comprised of two pressure control valves respectively arranged in a feed line and a return flow line, for operating the winding drum. The pressure control valves are provided to set a pressure differential on the hydraulic motor in order to maintain a defined tautness of the line being reeled in or paid out.

### CROSS-REFERENCES TO RELATED APPLICATIONS

This application claims the priority of German Patent Application, Serial No. 10 2010 015 624.8, filed Apr. 19, 2010, pursuant to 35 U.S.C. 119(a)-(d), the content of which is incorporated herein by reference in its entirety as if fully set forth herein.

### BACKGROUND OF THE INVENTION

The present invention relates to a winding drum, and to a method of operating a winding drum, in particular for use in telescopic booms of cranes.

The following discussion of related art is provided to assist the reader in understanding the advantages of the invention, and is not to be construed as an admission that this related art is prior art to this invention.

Winding drums are used in particular in mobile cranes for spirally winding lines, such as hydraulic hose lines. Coil springs are currently used on winding drums to generate a torque for maintaining the line taut when being reeled in or paid out. As the length of the boom of mobile cranes becomes increasingly longer, limits are reached when it comes to the construction of such coil springs because coil springs are difficult to handle at a certain size and pose a great risk for operators. Although it is conceivable to use electric motors for such winding drums, the presence of electric motors in mobile cranes would entail the need for additional cubicles which require added installation space and add weight so as to incur an increase in costs.

It would therefore be desirable and advantageous to address these problems and to obviate other prior art shortcomings.

### SUMMARY OF THE INVENTION

According to one aspect of the present invention, a method of operating a winding drum, in particular of cranes, for a line to be reeled in or paid out, includes the steps of activating a hydraulic motor by a control block, having a hydraulic valve assembly comprised of two pressure control valves respectively arranged in a feed line and a return flow line, for operating the winding drum, and setting a pressure differential on the hydraulic motor by the pressure control valves to maintain a defined tautness of the line being reeled in or paid out.

In accordance with a method of the invention for operating a winding drum, in particular for booms of cranes, such as mobile cranes, a line to be reeled in or paid out is spirally wound. The line may involve for example a dual hose line for hydraulic oil. To maintain the line taut during reeling in or paying out, the need for an electric motor or a mechanical coil spring is eliminated in favor of a particular hydraulic circuit, using a hydraulic motor.

The hydraulic motor has a construction which renders it suitable for a reverse operation and applies a substantially constant torque on the shaft of the winding drum in reel-in direction. Supply and operation of the hydraulic motor is realized via a control block which has incorporated therein several control members. Hydraulic pressure control valves are respectively arranged in a feed line and a return flow line of the hydraulic motor and provided to realize a defined pressure differential between the feed line and the return flow line of the hydraulic motor in proportion to the torque on the winding drum. Thus, a system is involved having a high-pressure side and a low-pressure side by which the reel-in direction is defined. The pressure on the low-pressure side can suitably lie in a range from 5 to 10 bar and is merely provided to apply a slight tension on the pay-out side for implementing a smooth run of the hydraulic motor during reeling in operation.

This configuration enables also a rapid reversal. The pressure difference is selected to maintain a defined tension of the line to be reeled in or paid out in all operating situations.

The hydraulic motor operates in reel-in direction as a motor and is supplied with fluid, e.g. oil, via the control block and the pressure line. In pay-out direction, the hydraulic motor is moved in opposition to the reel-in direction and thus operates as a generator. Oil is hereby pushed back via the control block into a reservoir.

The winding drum may further include several safety elements to prevent damage.

When no operating pressure is present at the connection of the control block, the winding function of the winding drum would no longer be ensured. To prevent uncontrolled unwinding of a hose line, the hydraulic motor is configured as brake motor. In combination with a pressure switch which signals a breakdown of the operating pressure and the pressure level in the brake line, and an electromagnetic directional control valve, the hydraulically controlled brake can be rendered operative. Moreover, the pressure switch allows control of a telescoping movement of the crane, i.e. the telescoping movement can be instantly stopped in the event of trouble.

As the brake system of hydraulic motors is not suitable for an operational slippage, when the brake is engaged and the fixedly set holding torque of the brake is generally much higher than the maximally set operating torque, the winding drum is provided at an appropriate location with a slip clutch which is set to a defined torque slightly above the operating torque (according to the pressure differential). This ensures in a conceivable operating situation in which the hydraulic fails or is turned off (i.e. no pressure oil supply at the control block) or when the brake is activated in a trouble situation, a telescoping out and thus prevents a breaking of the line. The slip clutch is set for example for slippage at a torque of 200 Nm. In normal operation, a torque of 80 Nm is transmitted from the hydraulic motor via the slip clutch.

The provided measures for braking the winding drum permit energy savings as the hydraulic supply can be turned off when no telescoping takes place. In order to ensure the tautness of the hose line at any time when turning on or off the operating pressure, the crane has to be equipped with control measures. Before turning off, the brake must always be activated (feedback via pressure switch) and before turning on and release of the brake, the operating pressure must be applied. Telescoping is cleared, when the pressure switch has indicated a release of the brake.

The hydraulic motor may involve a slow-speed engine which operates according to the Gerotor principle and is additionally coupled with the winding drum or its driveshaft through intervention of a gear mechanism, e.g. bevel gearing. Advantageously, a mechanical slip clutch is provided between the hydraulic motor and the gear mechanism.

The rotation speed of the winding drum depends on the telescoping speed and on the winding diameter of the hose line on the drum. Advantageously, the telescoping speed is 18 m/min and the maximum motor speed is about 15 rpm.

At a predefined required pulling force for maintaining tautness of the hydraulic dual hose line, which pulling force has to be built up via the motor torque, such an arrangement can be operated by a hydraulic motor with a delivery volume of 80 cm³/revolution. The minimum brake release pressure of such a hydraulic motor is 21 bar. The maximum operating pressure should not exceed 150 bar so as to account for the compressive load capability of the hydraulic motor including the brake. In the event, higher pressure are made available, the provision of a pressure reducing valve is required.

According to another advantageous feature of the present invention, the electromagnetically operated directional control valve can be activated when commencing the winding operation and after applying pressure upon the hydraulic motor in order to release the brake. The time difference may, for example, be 1 to 3 seconds, in particular 2 seconds. The electromagnet of the direction control valve can be coupled with the crane control in such a way that in the event of a telescoping, movement at the crane to reel in or pay out the line, the brake is also released, although at a slight time delay to ensure a constant tautness of the line to be reeled in or paid out.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a side view of one embodiment of a winding drum according to the present invention;

FIG. 2 is a side view of another embodiment of a winding drum according to the present invention; and

FIG. 3 is a hydraulic chart for the winding drum of FIGS. 1 and 2.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

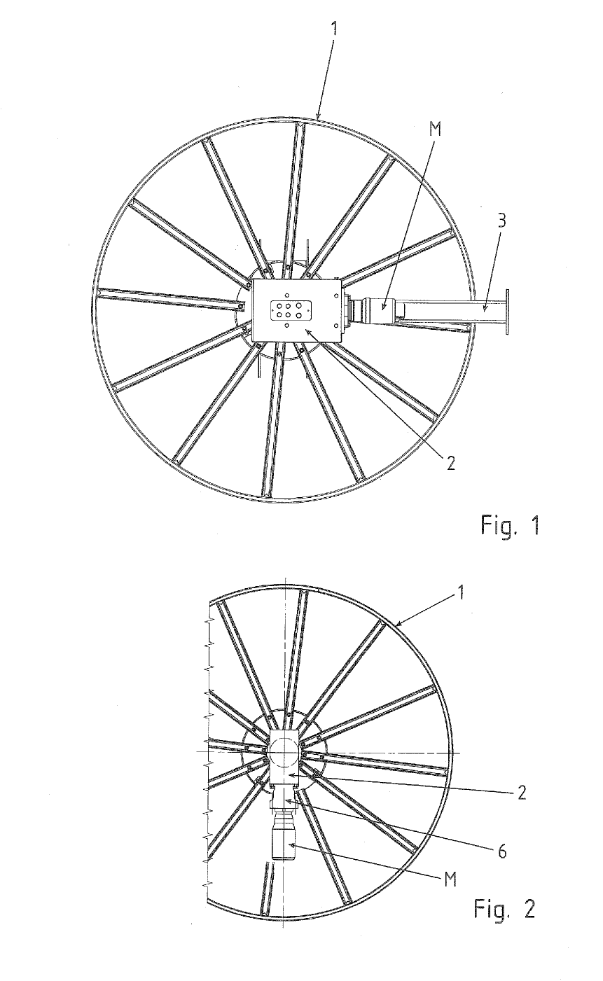

FIGS. 1 and 2 show side views of two winding drums 1 for use in a mobile crane and provided for spirally winding a hose line which is not shown in FIGS. 1 and 2 for ease of illustration. The line is maintained taut by a drive unit which includes a hydraulic motor M and a gear mechanism 2. The drive unit is supported on a support 3 so as to be able to introduce a torque into the winding drum 1.

In FIG. 2, a mechanical slip clutch 6 is shown between the winding drum 1 and the gear mechanism 2 and provides a safety feature for the hydraulically-operated winding drum 1. The slip clutch 6 is constructed in relation to a torque to ensure a slip-free transmission of the required maximum operating torque while still being significantly below the pulling force admissible for the line. This prevents a tearing of the line, when the crane hydraulics or the crane control fails.

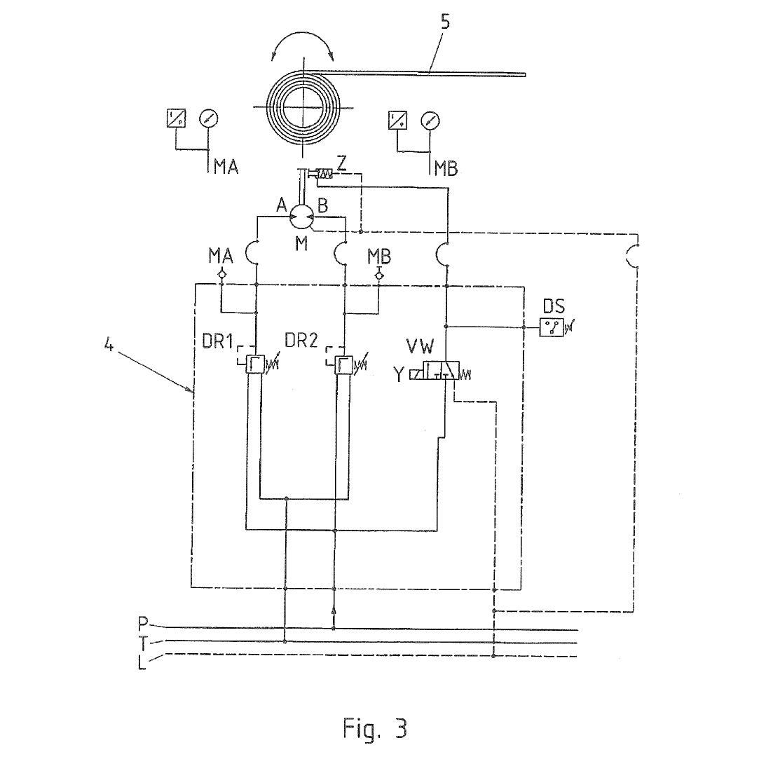

The principle of the control will now be described with reference to FIG. 3.

FIG. 3 shows a line 5 which is maintained at a defined tautness regardless whether the line is reeled in or paid out by the winding drum 1. The winding directions are indicated by the arrows. A control block 4 is shown in the lower drawing half of the hydraulic chart and includes several control elements such as hydraulic valves DR1, DR2, VW. The control block 4 controls a motor M. The motor connections for the hydraulic lines are labeled A and B to represent a feed line A and a return flow line B. The hydraulic valves DR1, DR2 are pressure control valves which are arranged in the feed line A and return flow line B, respectively. A pressure differential is established via the pressure control valves DR1, DR2. The pressure control valves DR1, DR2 are supplied from a line P with a required oil flow at a pressure of maximum 160 bar and at an oil flow of about 5 l/min. Measuring connections MA, MB are provided on the low-pressure side of the pressure control valves DR1, DR2. Manometers can be attached for control works.

The hydraulic valve VW of the control block 4 represents a directional control valve which can be actuated by an electromagnet Y. The directional control valve VW is operably connected to a brake Z which acts on the driveshaft of the hydraulic motor M in the unloaded state to block the driveshaft and the winding drum 1. When the electromagnet is activated, pressure is applied to the brake Z. The brake Z is released and the driveshaft is able to rotate.

The control block 4 further includes a pressure switch DS which is disposed in a line between the brake Z and the directional control valve VW to monitor the operating pressure which lies above the pressure applied on the pressure control valve DR1 by 10 to 20 bar and outputs to the crane control state signals about the brake Z on the hydraulic motor M.

The illustrated drive is incorporated into the hydraulic system of a mobile crane in particular. The electromagnet Y of the directional control valve VW and the pressure switch DS are integrated in the crane control.

The compact and hydraulic control block 4 with all connections is installed at a suitable location of the crane boom in proximity of the winding drum 1 and connected in accordance with the hydraulic chart as illustrated in FIG. 3 with the hydraulic motor M (connections A, B, Z, L) and the existing crane hydraulics (connections P, T, L), respectively.

The hydraulic valves DR1, DR2, VW in the control block 4 may be constructed as screw-in valves. Measuring connections MA, MB are provided for the default setting and supervision of the pressure control valves.

The following control scenarios are conceivable:

In the event, there is no operating pressure in the line P, brake Z of the motor M is rendered operative. This means that the electromagnet Y of the directional control valve VW is not supplied with current and the crane movement is at a standstill.

While the crane is at a standstill, the motor brake Z is activated before the central crane hydraulics is turned off. This means that the electromagnet Y of the directional control valve VW is not supplied with current.

When commencing operation of the crane, the crane hydraulics is activated and the brake Z is released with a time delay of about 2 sec so that the electromagnet Y of the directional control valve VW is activated via the control voltage of the crane.

It is possible in accordance with the present invention, to realize the required torque on the winding drum by means of a lightweight and compact hydraulic motor. The tailored setting of the pressure control valves DR1, DR2 ensures generation of a torque at the winding drum 1 sufficient to maintain a tautness of the line. The motor line pressures are set when the winding drum 1 is at a standstill, using the pressure control valves DR1, DR2, with the pressure being monitored by the measuring connections MA, MB. Basically, the resistance pressure for the hydraulic motor on the motor line B is set to about 5 to 10 bar. Subsequently, the operating pressure is set high enough by the pressure control valve DR1 at the motor line A to ensure the required tautness of the hose line.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of operating a winding drum, in particular of cranes, for a line to be reeled in or paid out, comprising the steps of:
activating a hydraulic motor by a control block, having a hydraulic valve assembly comprised of two pressure control valves respectively arranged in a feed line and a return flow line, for operating the winding drum; and
setting a pressure differential on the hydraulic motor by the pressure control valves to maintain a defined tautness of the line being reeled in or paid out.

2. The method of claim 1, further comprising the steps of holding the winding drum in an idle position by a brake, and applying a hydraulic resistance pressure in opposition to a reel-in direction, when starting a winding operation and before the hydraulic motor is operated with an operating pressure at a magnitude which is sufficient to ensure tautness of the line.

3. The method of claim 2, wherein the resistance pressure is adjusted in a range from 5 to 10 bar.

4. The method of claim 2, further comprising the step of controlling the brake acting on the winding drum by a directional control valve incorporated in the control block.

5. The method of claim 4, further comprising the steps of arranging a pressure switch between the directional control valve and the brake, defining a switching point for the pressure switch of 10 to 20 bar above a pressure applied on one of the pressure control valves for the operating pressure of the hydraulic motor, and rendering operative the pressure switch, when the pressure drops.

6. The method of claim 1, further comprising the steps of operating the hydraulic motor according to the Gerotor principle, and coupling the hydraulic motor with the winding drum through intervention of a gear mechanism.

7. The method of claim 1, further comprising the step of coupling the hydraulic motor with the winding drum via a mechanical slip clutch.

8. The method of claim 4, further comprising the steps of operating the directional control valve by an electromagnet which is activated when commencing the winding operation and after applying pressure upon the hydraulic motor in order to release the brake.

9. A winding drum, in particular of a crane, for a line to be reeled in or paid out, comprising:
a hydraulic motor having a feed line and a return flow line; and
a control block having a hydraulic valve assembly for operating the hydraulic motor, said hydraulic valve assembly including two pressure control valves respectively arranged in the feed line and the return flow line of the hydraulic motor, said pressure control valves being constructed to set a pressure differential on the hydraulic motor to maintain a defined tautness of the line being reeled in or paid out.

10. The winding drum of claim 9, further comprising a pressure supply system of a crane for supply of pressure to the hydraulic motor.

11. The winding drum of claim 9, further comprising a directional control valve for controlling a brake acting on the winding drum.
